(19) United States
(12) Patent Application Publication
(10) Pub. No.: US 2014/0352505 A1
(43) Pub. Date: Dec. 4, 2014

(54) INDUSTRIAL SLICER

(71) Applicant: GIORGIO GRASSELLI, ALBINEA (IT)

(72) Inventor: GIORGIO GRASSELLI, ALBINEA (IT)

(21) Appl. No.: 14/283,670

(22) Filed: May 21, 2014

(30) Foreign Application Priority Data
May 30, 2013 (IT) MI2013A000882

(51) Int. Cl. B26D 5/00; B26D 7/06

(52) U.S. Cl. CPC B26D 5/005; B26D 7/0625; B26D 2210/04
USPC 83/13; 83/422

(57) ABSTRACT

It is disclosed an industrial slicer of a food product. The slicer comprises means for guiding and conveying the food product along a conveying direction, comprises means for pressing the food product against the guiding and conveying means, wherein the minimum distance between the pressing means and the guiding and conveying means is configurable, comprises means for cutting the food product into a plurality of pieces according to a configured cutting pitch, comprises pre-pressing means for exerting a pressure value on the food product and comprises a control unit. The control unit is configured to calculate a number of cutting pieces. The cutting means are configured to cut the pressed food product into a number of pieces equal to the calculated number of cutting pieces.

### BACKGROUND

1. Technical Field

The present disclosure generally relates to the field of the industrial slicers. More specifically, the present disclosure concerns a slicer for the food industry for cutting products such as meat, poultry, fish or other food products with similar characteristics, including both fresh and cooked products without bones or cartilage.

2. Description of the Related Art

Known industrial slicers comprise a lower belt that conveys the product to be cut, an upper belt that has the function of pressing the product as it is being cut so as to keep it in a fixed position with respect to the lower belt, and one or more blades mounted in proximity to the upper belt so as to cut the product into slices, strips or cubes of various dimensions.

The upper belt can be fixed or floating; in this latter case, it is controlled by a pneumatic pressure or by the mechanical pressure of a spring.

The Applicant has observed that one disadvantage of the slicers having a fixed upper belt is to require that the food product to be cut is calibrated (that is, that the weight and dimensions thereof are substantially constant), otherwise the cut pieces will not be uniform and they are not of good quality. Slicers having the floating upper belt, instead, allow to obtain uniformly cut pieces, but they have the drawback that an excessive amount of food product is discarded.

### BRIEF SUMMARY

The present disclosure relates to an industrial slicer as defined in the e closed claim 1 and by its preferred embodiments disclosed in the dependent claims from 2 to 7.

The Applicant has perceived that the industrial slicer according to the present disclosure allows to obtain from the food product a number of uniform pieces (for example, having a thickness which is substantially equal each other) and of good quality, reducing at the same time the amount of food product that is discarded. Moreover, it has the advantage to allow to obtain high production volumes.

It is also an object of the present disclosure a method for cutting a food product into slices as defined in the enclosed claim 8 and in the preferred embodiments disclosed in the dependent claims 9 to 13.

It is also an object of the present disclosure a computer readable medium as defined in the enclosed claim 14.

### BRIEF DESCRIPTION OF THE SEVERAL VIEWS OF THE DRAWINGS

Further characteristics and advantages of the disclosure will result from the following description of a preferred embodiment and variants thereof provided by way of example with reference to the accompanying drawings, wherein:

FIG. 1 shows a schematic perspective view of an industrial slicer according to an embodiment of the disclosure;

FIG. 2 shows a schematic view of the cross section of the industrial slicer according to e embodiment of the disclosure;

FIGS. 3A-3B show two schematic perspective views of means for pre-pressing the food product of the industrial slicer according to the embodiment of the disclosure;

FIG. 4A shows a partial schematic sectional view of the industrial slicer according to the embodiment of the disclosure;

FIG. 4B is a simplified, partial perspective view of the industrial slicer according to the embodiment of the disclosure;

FIG. 5 is a flow diagram of a method for cutting a food product into a plurality of pieces according to the embodiment of the disclosure.

### DETAILED DESCRIPTION

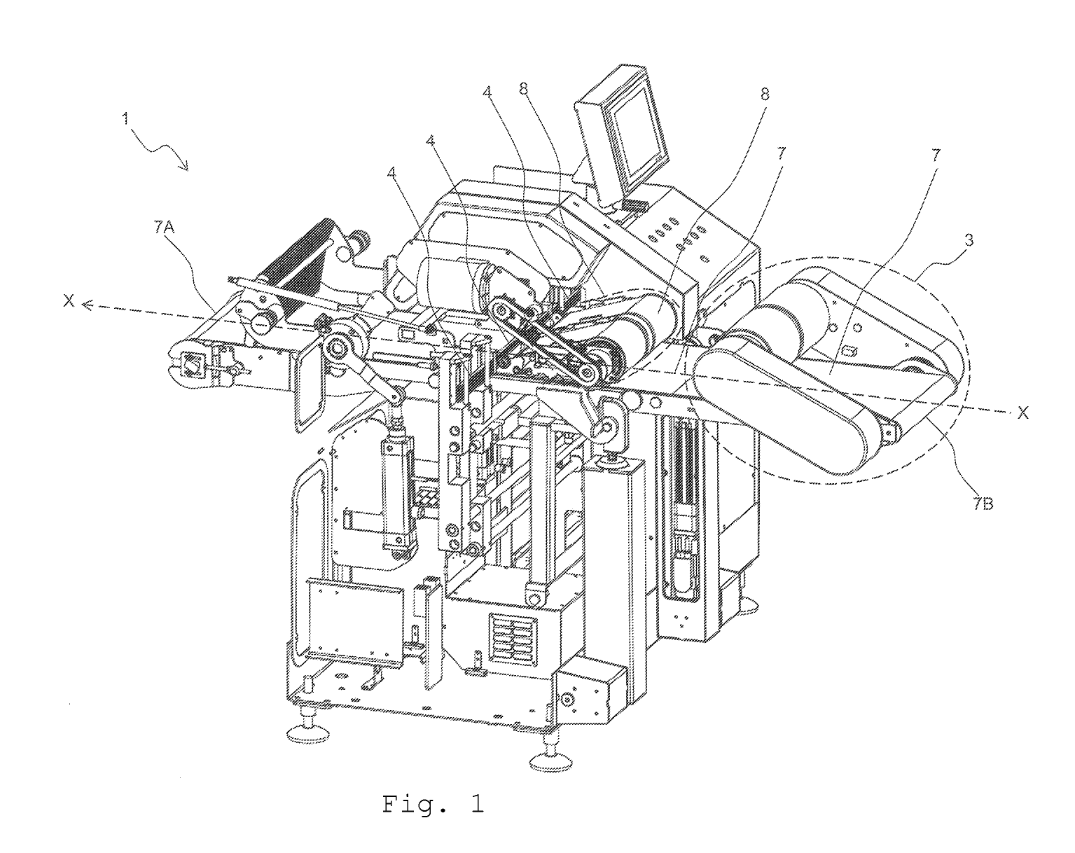

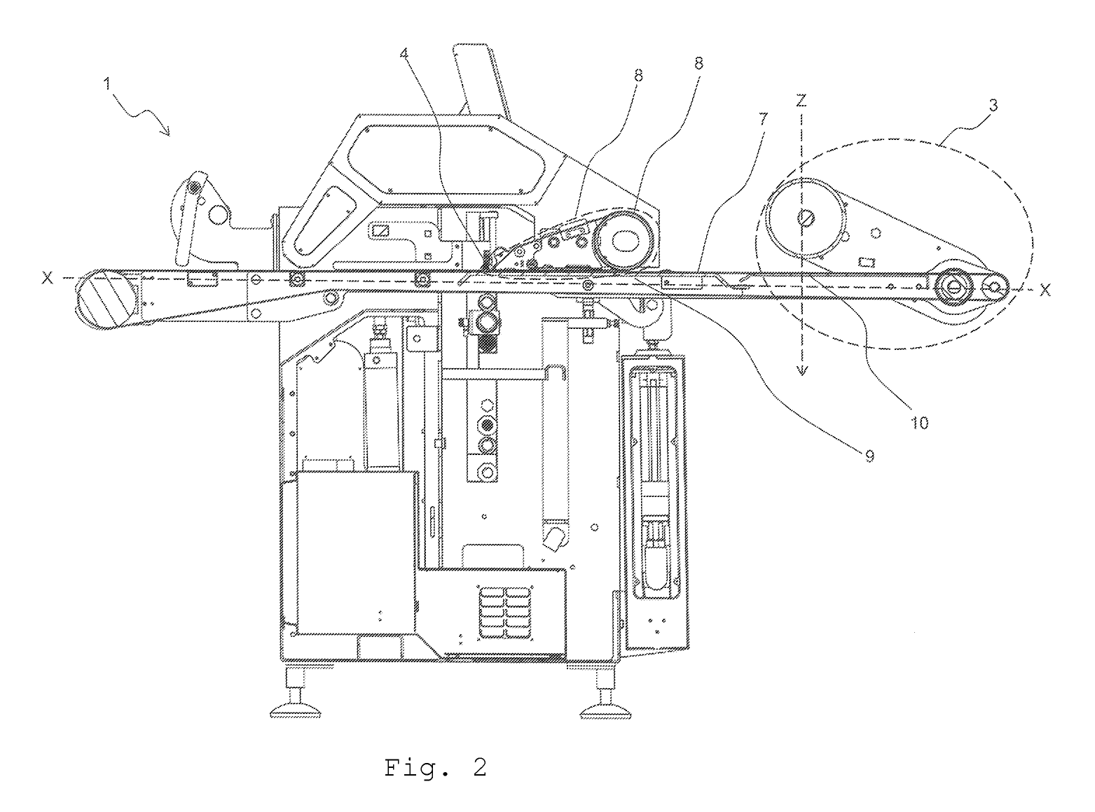

Referring to FIGS. 1 and 2, they show a schematic perspective view and a schematic view of the cross-section of an industrial slicer 1 according to an embodiment of the disclosure.

The industrial slicer 1 performs the cut of a food product into pieces that can be slices, strips or cubes. The food product can be a piece of meat, poultry, fish or other food products with similar characteristics, including both fresh and cooked products, as long as they are without bones or cartilage.

The industrial slicer 1 comprises:
a frame;
means 7 for guiding and conveying the product;
pressing means 8;
means 4 for cutting the product;
pre-pressing means 3;
a control unit.

The frame has the function of supporting the structural and movable elements of the industrial slicer 1.

The guiding and conveying means 7 have the function of conveying the food product to be cut towards the cutting means 4, along a conveying direction X for the food product.

The pressing means 8 have the function of pressing the food product to be cut against the guiding and conveying means 7, in order to keep the food product into a fixed position with respect to the guiding and conveying means 7 as it is being cut arid to allow a precise cut of the food product. Moreover, the minimum distance H1z (see FIG. 48) between the pressing means 8 and the guiding and conveying means 7 is configurable, that is it can be changed by the control unit in order to optimising the cutting process, as it will be explained in further detail below.

The cutting means 4 have the function of cutting the food product into a plurality of pieces, according to a configured cutting pitch S, that is set by the user of the industrial slicer 1 before the beginning of the process of cutting the food product; furthermore, the cutting means 4 are configured to cut the food product into a number of pieces that is calculated by the control unit, as it will be explained in further detail below.

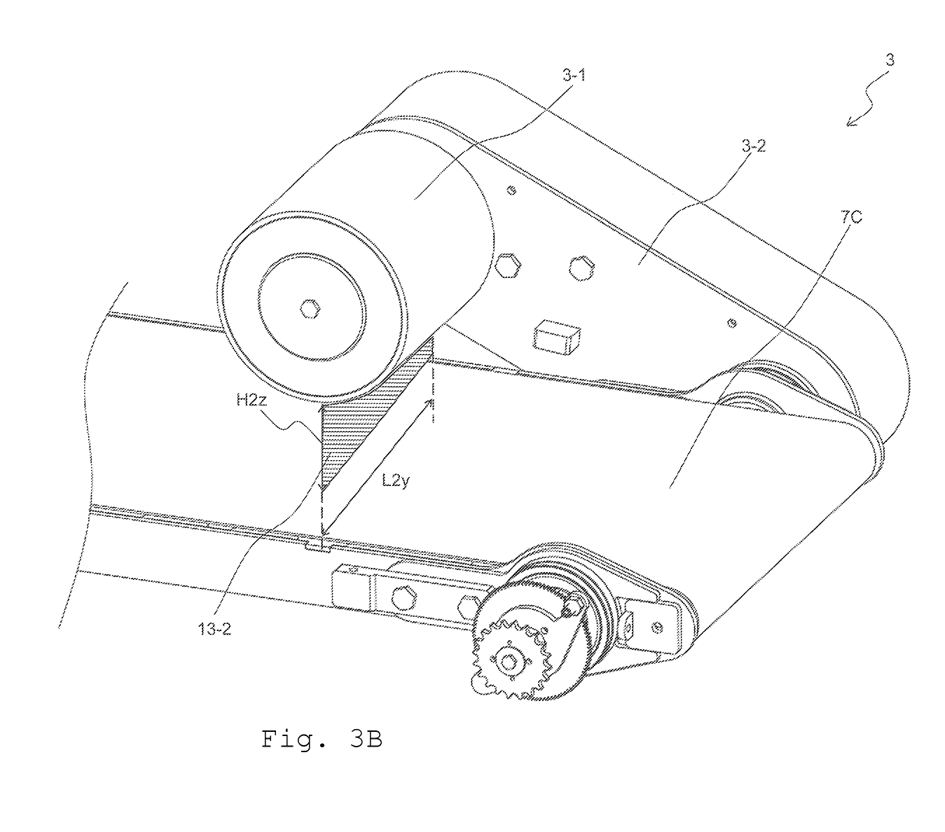

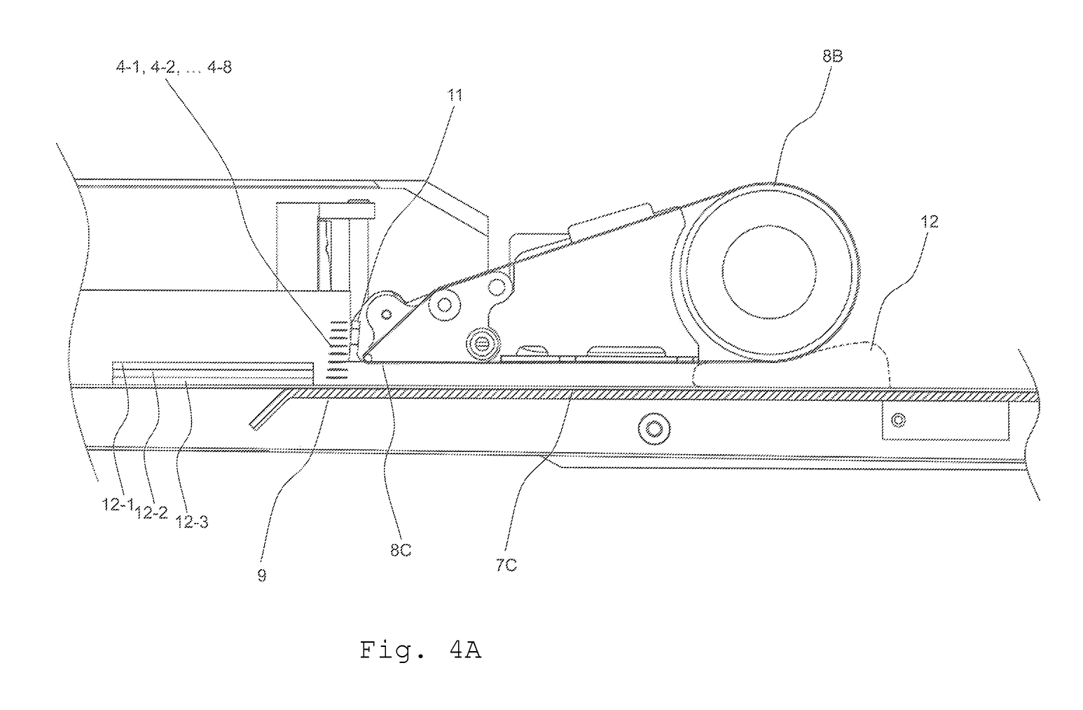

In one embodiment, with reference to FIGS. 4A and 48, the cutting means 4 are made of a plurality of parallel blades 4-1, 4-2, 4-3 having a cutting plane Pt parallel to the conveying direction X and a cutting movement in a direction Y that is perpendicular to the conveying direction X.

It is observed that FIG. 4B is a simplified view compared to that of FIG. 4A.

Advantageously, the cutting movement of the plurality of blades 4-1, 4-2, 4-3 is an alternative movement in the opposite direction, so as to improve the stability of the food product during the cutting process. The pitch S between the blades 4-1, 4-2, 4-3 is set by the user of the industrial slicer 1 before the cutting process, as a function of the desired thickness of the pieces. It is observed that for the sake of simplicity, eight blades 4-1, 4-2 . . . 4-8 are shown in FIG. 4A and three blades 4-1, 4-2, 4-3 are shown in FIG. 48, but more in general the number of blades present is greater than one.

The pre-pressing means 3 are configured to exert a pressure value P1 on e food product, by means of a force in a direction Z that is substantially perpendicular to the conveying direction X. In this way the working condition of the food product during the cutting process is simulated, wherein the food product is pressed so as to be kept in a fixed position with respect to the guiding and conveying means 7 and thus it can be cut precisely: this allows the control unit to calculate a dimension of the food product under conditions similar to the actual working conditions, as it will be explained in further detail herein below. Moreover, the pressure P1 exerted by the pre-pressing means 3 allows to reduce the maximum height of the food product.

The pressure value P1 is configured by the user of the industrial slicer 1 before the beginning of the process of cutting the food product and it is kept constant at the value P1 during the cutting process. The value of pressure P1 depends on the type of food product (for example, beef or poultry) and on the type of preservation employed for the food product (for example, whether the product has just left the refrigerator or it is at ambient temperature).

The control unit has the function to contrail the movement of the guiding and conveying means 7, the movement of the pressing means 8 and the movement of the cutting means 4, by means of suitable electric motors.

The control unit also has the function of calculating the dimension of the pressed food product, that is under the conditions wherein the food product to be cut is subjected to the pressure value P1 exerted by the pre-pressing means 3, For example, the dimension of the food product is the height of the food product with respect to the plane defined by the guiding and conveying means 7 (that is, with respect to the plane XY); in the case wherein the height of the food product is variable, the calculated dimension of the food product is the maximum height of the food product.

The control unit also has the function of calculating, as a function of the calculated dimension of the food product and of a configured cutting pitch S, a number of cutting pieces, as it will be explained in further detail herein below.

The control unit also has the function of calculating, as a function of the calculated number of cutting pieces and of the configured cutting pitch S, a cutting dimension of the food product, as it will be explained in further detail herein below; in particular, the cutting dimension is calculated by further taking into account one or more correction parameters set by the user, which depend on the type of food product and on the operating conditions.

The control unit also has the function of setting the value for the minimum distance H1z between the pressing means 8 and the guiding and conveying means 7 equal to the value of the calculated cutting dimension of the food product.

The control unit also has the function of controlling the movement of the guiding and conveying means 7 in order to convey the food product through the minimum distance H1z that is substantially equal to the value of the calculated cutting dimension, as it will be explained in further detail herein below.

The control unit can be mounted on the industrial slicer 1 or it can be external thereto.

The control unit is for example of a programmable logic circuit or a microcontroller which is configured to execute the above indicated functionalities. Alternatively, the control unit can be a micro-processor which is configured to execute software code portions that implement the above indicated functionalities.

In one embodiment, the guiding and conveying means 7 are composed of a conveyor belt 70 arranged in a closed loop on a pair of rollers 7A, 7B, wherein one is the driving roller and the other is the driven roller and wherein the conveyor belt 70 is structured to define the conveying direction X. In this case, the plane XY corresponds to the upper surface defined by the conveyor belt 70. In a similar manner, the pressing means 8 are constituted by a pressing belt 80 arranged in a closed loop on a pair of rollers 8A, 8B, wherein one is the driving roller and the other is the driven roller, and wherein the direction defined by the lower surface of the pressing belt 80 is inclined with respect to the direction defined by the upper surface of the conveyor belt 70.

Moreover, there is a rigid plane surface 9 (for example, made of steel) below the conveyor belt 70, said plane surface 9 being substantially parallel to the plane defined by the conveyor belt 70 and extending in length at least along the roller 8A of the pressing belt 80; in this manner, the food product to be cut is placed on the upper surface of the conveyor belt 70, is conveyed towards the roller 8A, comes into contact with the roller 8A and at that point it is pressed against the conveyor belt 70.

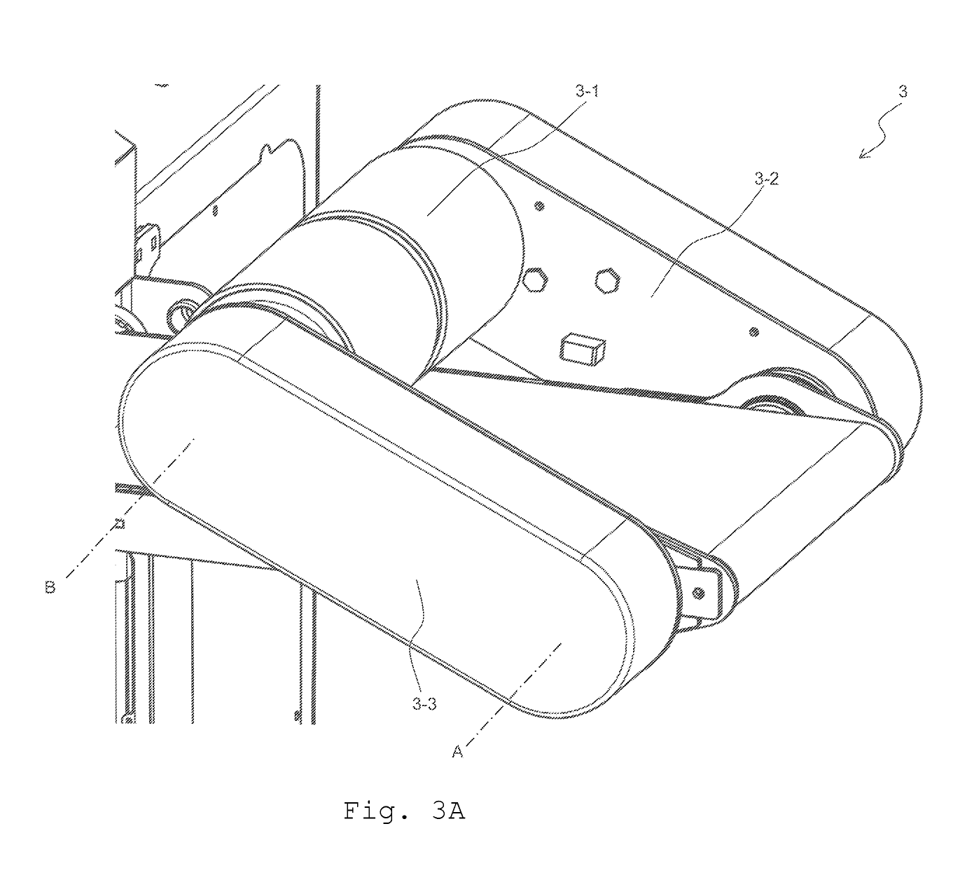

Advantageously, referring to FIGS. 3A and 3B, the pre-pressing means 3 are implemented with a rotating roller 3-1 having a peripheral velocity equal to that of the conveyor belt 70 and a rotation direction parallel to the conveying direction X. The rotating roller 3-1 is supported oscillatably around an oscillation axis in such a way to result liftable with respect to the upper surface of the conveyor belt 70. In particular, the rotating roller 3-1 is rotatably mounted around an axis “B” on a pair of arms 3-2, 3-3, which are hinged to a portion of the frame so as to rotate around a respective oscillation axis “A” which is parallel and shifted with respect to the rotation axis “8” of the rotating roller 3-1. In this case, the control unit is configured to receive a signal indicating the angle defined by the arm 3-2 (or by the arm 3-3) when the food product passes under the roller 3-1 and it is configured to calculate, as a function of the value of said signal, the dimension of the pressed food product, in particular the height thereof with respect to the plane defined by the upper surface of the conveyor belt 7.

The oscillation lifting the rotating roller 3-1 undergoes the action of at least one opposing spring (in particular, one spring per arm) that operated in such a manner as to keep the rotating roller 3-1 pressed against the conveyor belt 70.

In one embodiment, the spring is applied to the arm 3-2 in an adjustable manner, in particular it has a plurality of positions for attachment to the arm 3-2 in such a manner as to implement a plurality of values for the pressure P1 exerted on the food product that is conveyed on the conveyor belt 7C and comes into contact with the roller 3-1. The same considerations apply to the spring applied to the arm 3-3.

Moreover, there is a rigid plane surface 10 (for example, made of steel) below the conveyor belt 70, said plane surface 10 being substantially parallel to the plane defined by the upper surface of the conveyor belt 70 and extending in length at least along the roller 3-1; in this way the food product to be cut is placed on the upper surface of the conveyor belt 70, is conveyed towards the roller 3-1, comes into contact with the roller 3-1 which is lifted upwards with respect to the upper surface of the conveyor belt 70 and at that point the food product is pressed against the conveyor belt 70.

FIG. 38 differs from FIG. 3A in that the arm 3-3 and part of the rotating roller 3-1 connected thereto have been eliminated. In FIG. 38 an opening 13-2 (indicated by the area marked with diagonal lines) can be defined, said opening 13-2 having in the direction Y (that is, the direction perpendicular to the upper surface of the conveyor belt 70) width L2y equal to the width of the conveyor belt 70 and having in the direction Z a height H2z defined by the distance between the upper surface of the conveyor belt 70 and the surface of the roller 3-1.

The roller 3-1 is lifted upwards with respect to the surface of the conveyor belt 70 (more precisely, following a arc-shaped trajectory of a circle centred on the oscillation axis “A” of the arms 3-2, 3-3) following the height of the food product as it is conveyed along the conveyor belt 7C and passes through the opening 13-2, wherein the food product is in contact with the roller 3-1 that rolls over the food product.

Referring to FIG. 48, an opening 13-1 (indicated by the area marked with diagonal lines) can be defined in proximity to the blades 4-1, 4-2, 4-3, said opening 13-1 having in the direction Y (that is, the direction perpendicular to the upper surface of the conveyor belt 70) a width L1y equal to the width of the conveyor belt 70 and having in the direction Z a height H1z defined by the distance between the upper surface of the conveyor belt 7C and the lower surface of the pressing belt 8C at the point where it is wound around the roller 8A.

In one embodiment, a guiding plate 11 (see FIG. 4A) is interposed between the pressing belt 8 and the plurality of blades 4-1, 4-2, 4-3, said guiding plate having the function of maintaining the food product in a pressed configuration preventing the food product from tending to return to an expanded configuration at the end of the pressing belt 80 (that is, at the winding point around the roller 8A) and thus preventing irregular cutting of the food product. In particular, said guiding plate 11 facilitates detachment of the food product from the pressing belt 8, as it acts as a scraping element.

It will be described hereinafter the method for cutting the food product into a plurality of pieces, referring also to FIGS. 1-4.

It is supposed that the food product is a piece of meat (e.g. poultry) and that the cut pieces are slices of meat 12-1, 12-2, 12-3.

It is supposed to use the conveyor belt 70, the pressing belt 8C and the rotating roller 3-1.

It is further supposed that the cutting means are composed of twenty blades 4-1, 4-2 . . . 4-20 with the cutting plane Pt parallel to the conveying direction)(and an alternative cutting movement in the direction Y perpendicular to the conveying direction X, wherein the value of the pitch S between the blades 4-1, 4-2 . . . 4-20 has been set at 4 millimetres by the user.

It is also supposed to measure the height of the piece of meat with respect to the plane defined by the upper surface of the conveyor belt 70.

It is also supposed that the user of the industrial slicer 1 has configured the pressure value P1 between the rotating roller 3-1 and the conveyor belt 70, as a function of the type of food product (i.e., the piece of meat is poultry meat).

At time tₒ the piece of meat to be cut is placed on the upper surface of the conveyor belt 7C, to the right of the rotating roller 3-1 in the normal orientation shown in FIGS. 1-4.

In the interval comprised between t₁ (subsequent to t₀) and t₂ (subsequent to t₁),the piece of meat is guided on the upper surface of the conveyor belt 7C in the conveying direction X (that is, towards the plurality of blades 4-1, 4-2 . . . 4-20).

At time t₃ (subsequent to t₂), the piece of meat starts to pass through the opening 13-2 defined between the conveyor belt 70 and the surface of the roller 3-1; the piece of meat comes into contact with the roller 3-1 and thus it begins to be pressed at a pressure having a value equal to the pressure value P1, by means of the pressure exerted by the roller 3-1 against the conveyor belt 7C. The control unit calculates a transition of the height of the piece of meat from a value equal to zero to a value greater than zero (for example, equal to 5.3 centimetres) and thus it detects the presence of the piece of meat.

In the interval comprised between t₄ (subsequent to t₃) and t₆ (subsequent to t₄) the piece of meat passes through the entire opening 13-2 defined between the surface of the roller 3-1 and the upper surface of the conveyor belt 70; the roller 3-1 rolls over the upper surface of the piece of meat, continues to exert the pressure P1 on the piece of meat and the roller 3-1 is also lifted upwards with respect to the surface of the conveyor belt 70, following the variable height of the piece of meat. The control unit calculates the several values of the heights of the piece of meat pressed at the pressure value P1. Upon completion of this pre-pressing step the maximum height of the piece of meat is lower.

At time t₆ (subsequent to t₅) the control unit detects that the height of the piece of meat is equal to zero: this indicates that the piece of meat has passed through the entire opening 13-2 defined between the surface of the roller 3-1 and the upper surface of the conveyor belt 70. The control unit then calculates the maximum height Hₘₐₓ among the values of the calculated heights (for example, Hₘₐₓ=6.2 cm). It is noted that the values of the heights of the piece of meat are calculated when the piece of meat is pressed, in particular when it is pressed at a pressure value equal to the configured pressure value P1; in this way the working condition of the piece of meat during the cutting process is simulated, wherein the piece of meat is pressed so as to be maintained in a fixed position with respect to the conveyor belt 70 and be cut precisely. Moreover, at time t₆ the control unit calculates the number N of slices of meat, as a function of the maximum height Hₘₐₓ of the piece of meat and of the configured cutting pitch S. For example, let's consider Hₘₐₓ=6.2 cm and S=4 mm; the control unit performs the division of the value of Hₘₐₓ by the value of S, obtaining the value N_d=15.5. The value N_d is typically a decimal number, which can be rounded down or up to an integer number, that is to 15 or 16 respectively. Let's assume that the value N_d=15.5 is rounded down to the integer number 15, thus obtaining the number of slices of meat N=15; this means that it is possible to obtain fifteen slices of meat of good quality from the piece of meat, all having a thickness substantially equal to 4 mm, thereby minimising or even eliminating waste (that is, the amount of slices that are not considered to be of good quality, for example because they do not conform to the required thickness).

Moreover, at time t₆ the control unit calculates the value of a cutting height for the piece of meat, as a function of the calculated number of slices N and of the cutting pitch S. In the considered example , the control unit performs a multiplication of the calculated number of slices N=15 by the cutting pitch S=4 mm, thereby obtaining the cutting height equal to 6 cm.

As a result, at time t₆ the control unit 1 sets the value for the distance H1z between the upper surface of the conveyor belt 7C and the pressing belt 8C (at the point where it is wound around the roller 8A) equal to the calculated value of the cutting height. In the considered example, the control unit 1 sets the distance H1z equal to 6 cm; in this way fifteen blades 4-1, 4-2 . . . 4-15 are uncovered and these blades will allow to obtain N=15 slices of meat (see the subsequent intervals comprised between t₈ and t₁₀).

In the interval comprised between t₇ (subsequent to t₆) and t₈ (subsequent to t₇) the control unit drives the movement of the conveyor belt 70 and conveys the piece of meat 12 towards the roller 8A of the pressing belt 8C.

At time t₈ (subsequent to t₇) the piece of meat 12 begins to pass through the opening 13-1 defined in proximity to the blades 4-1, 4-2 . . . 4-20, between the conveyor belt 70 and the pressing belt 80 at the point where it is wound around the roller 8A, wherein the distance H z between the conveyor belt 70 and the pressing belt 8C is equal to the previously calculated value of the cutting height (in the considered example, H1z=6 cm): the food product thus begins to be pressed.

In the interval comprised between t₉ (subsequent to t₈) and t₁₀ (subsequent to t₉) the piece of meat 12 passes through the opening 13-1 defined between the conveyor belt 7C and the pressing belt 80 at the point where it is wound around the roller 8A; the piece of meat 12 continues to be pressed (in the considered example, at a pressure P2 slightly higher than the first pressure value P1) and is then maintained in a fixed position with respect to the conveyor belt 7C. At this point, the blades 4-1, 4-2, . . . 4-15 begin to cut the piece of meat 12 into the previously calculated number of slices N (in the considered example, N=15). The conveyor belt 70 continues to convey the partially cut piece of meat in the conveying direction X; in this manner, the piece of meat continues to be cut by the blades 4-1, 4-2, . . . 4-15, until it is cut completely and thus the number N of slices of meat 12-1, 12-2, 12-3, . . . is obtained (in the considered example, N=15).

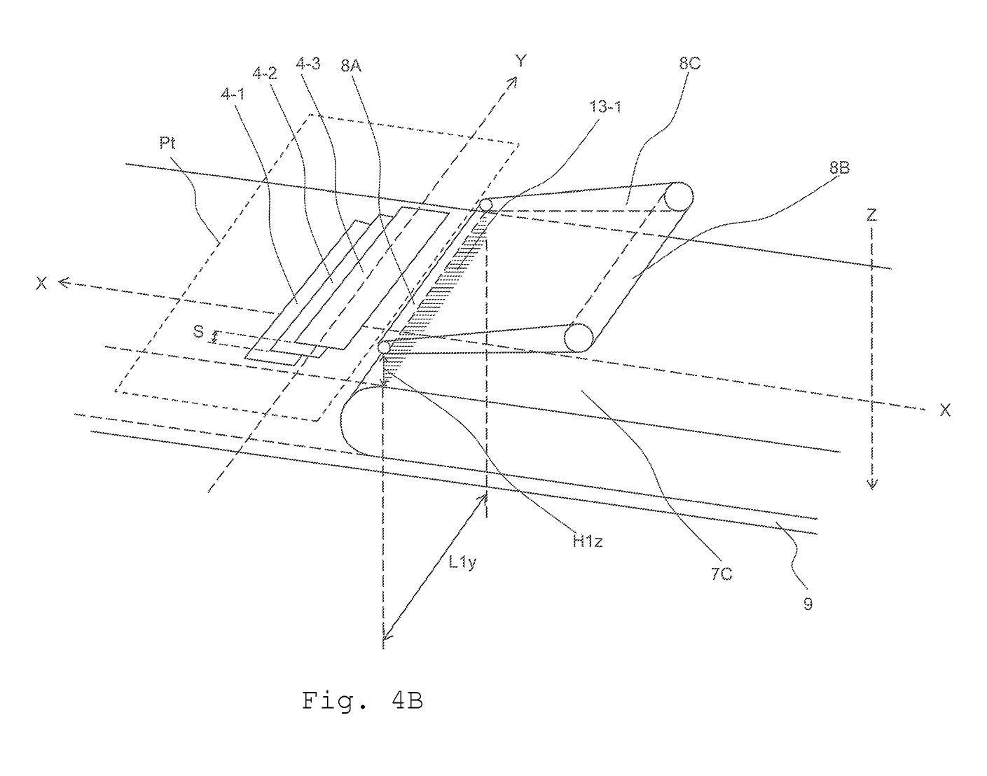

It is alo an object of the present disclosure a method 500 for cutting a food product into a plurality of pieces, as shown in FIG. 5.

In particular, in step 501 the food product is conveyed over the means 7 for guiding and conveying the product along the conveying direction X.

In step 502 a first pressure value P1 is exerted on the food product and a dimension of the food product is calculated.

In step 503 a number of cutting pieces is calculated, as a function of the dimension of the product and of a configured cutting pitch.

In step 504 a cutting dimension for the food product is calculated, as a function of the calculated number of cutting pieces and of the configured cutting pitch.

In step 505 the food product is conveyed over the guiding and conveying means 7, pressing the food product through the opening 13-1 having the dimension H1z equal to the cutting dimension.

In step 506 the pressed food product is cut into a number of pieces N equal to the calculated number of cutting pieces.

Calculation of the dimension of the food product in step 502 and in steps 503, 504 is carried out by means of software code portions, which executed on the control unit mounted on the industrial slicer 1 or externally thereto.

1. Industrial slicer of a food product, the slicer comprising:
means for guiding and conveying the food product along a conveying direction;
means for pressing the food product against the guiding and conveying means, wherein the minimum distance between the pressing means and the guiding and conveying means is configurable;
means for cutting the food product into a plurality of pieces according to a configured cutting pitch;
pre-pressing means for exerting a pressure value on the food product;
a control unit configured to:
calculate a dimension of the pressed food product;
calculate, as a function of the dimension of the food product and of a configured cutting pitch, a number of cutting pieces;
calculate, as a function of the calculated number of cutting pieces and of the configured cutting pitch, a cutting dimension of the food product;
set the value for the minimum distance between the pressing means and the guiding and conveying means equal to the value of the cutting dimension
control the movement of the guiding arid conveying means in order to convey the food product pressing it through the minimum distance equal to the value of the cutting dimension;
wherein the cutting means are configured to cut the pressed food product into a number of pieces equal to the calculated number of cutting pieces.

2. Industrial slicer according to claim 1, wherein the control unit is configured to calculate the number of cutting pieces by dividing the calculated dimension of the food product by the configured cutting pitch and rounding the result of the division up or down to the preceding or following integer number,
and wherein the control unit is configured to calculate the cutting dimension by multiplying the rounded result of the division by the configured cutting pitch.

3. Industrial slicer according to claim 1, wherein the guiding and conveying means are a conveyor belt and the pressing means are a pressing belt having a length shorter than the length of the conveyor belt,
wherein the pre-pressing means comprises:
a rotating roller having a peripheral velocity substantially equal to that of the conveyor belt and being oscillating with respect to the surface of the conveyor belt;
at least one arm for connecting the rotating roller to a portion of the frame;
wherein the control unit is configured to:
detect the angle defined by at least one arm when the food product passes under the rotating roller;
calculate, as a function of the detected angle, the value of the minimum distance between the conveyor belt and the pressing belt.

4. Industrial slicer according to claim 2, wherein the guiding and conveying means are a conveyor belt and the pressing means are a pressing belt having a length shorter than the length of the conveyor belt,
wherein the pre-pressing means comprises:
a rotating roller having a peripheral velocity substantially equal to that of the conveyor belt and being oscillating with respect to the surface of the conveyor belt;
at least one arm for connecting the rotating roller to a portion of the frame;
wherein the control unit is configured to:
detect the angle defined by at least one arm when the food product passes under the rotating roller;
calculate, as a function of the detected angle, the value of the minimum distance between the conveyor belt and the pressing belt.

5. Industrial slicer according to claim 2, wherein the cutting means have a cutting plane that is substantially parallel to the conveying direction and have a cutting movement in a direction that is substantially perpendicular to the conveying direction,
wherein the dimension of the food product is the height of the food product with respect to the plane defined by the guiding and conveying means,
and wherein the direction of the minimum distance is substantially perpendicular to the plane defined by the guiding and conveying means.

6. Industrial slicer according to claim 1, wherein the dimension of the food product is the maxim dimension of the food product, in particular the maximum height.

7. Industrial slicer according to claim 3, further comprising a guiding plate interposed between the pressing belt and the cutting means, configured to keep the food product pressed during the cutting process.

8. Method for cutting a food product into a plurality of pieces, comprising the steps of:
conveying the food product over means for guiding and conveying the food product along a conveying direction;
b) exerting a pressure value on the food product and calculating a dimension of the pressed food product;
c) calculating, as a function of the dimension of the food product and of a configured cutting pitch, a number of cutting pieces;
d) calculating, as a function of the calculated number of cutting pieces arid of the configured cutting pitch, a cutting dimension for the food product;
e) conveying the food product over the guiding and conveying means and pressing it through an opening having a dimension equal to the cutting dimension;
f) cutting the pressed food product into a number of pieces equal to the calculated number of cutting pieces.

9. Method according to claim 8, wherein in step c) the number of cutting pieces is calculated by dividing the dimension of the food product by the configured cutting pitch and rounding the result of the division up or down to the preceding or following integer number, and wherein in step d) the cutting dimension is calculated by multiplying the rounded result of the division by the configured cutting pitch.

10. Method according to claim 9, wherein the dimension of the food product is the maximum dimension of the food product.

11. Method according to claim 9, wherein the dimension of the food product is the maximum height of the food product with respect to the plane defined by the guiding and conveying means.

12. Method according to clam 11, wherein in step e) said dimension (H1z) has a direction which is substantially perpendicular to the plane (XY) defined by the guiding and conveying means.

13. Method according to claim 12, wherein in step f) said cutting is performed in a cutting plane (Pt) which is substantially parallel to the conveying direction (X) and which has a cutting movement in a direction (Y) that is substantially perpendicular to the conveying direction (X).

14. Computer readable medium having a program recorded threreon, said computer readable medium comprising computer code means adapted to perform the calculation of step b) and the steps c), d) of the method according to claim 8, when said program is run on a computer.
